(19) United States
(12) Patent Application Publication
(10) Pub. No.: US 2006/0088802 A1
(43) Pub. Date: Apr. 27, 2006

(54) Tape cartridge and tape processing apparatus on which tape cartridge is detachably mounted

(75) Inventor: Masao Akaiwa, Shiojiri-Shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/245,397

(22) Filed: Oct. 5, 2005

(30) Foreign Application Priority Data
Oct. 21, 2004 (JP) 2004-307329

(51) Int. Cl. G09B 21/00

(52) U.S. Cl. 434/113

(57) ABSTRACT

A tape cartridge includes a process tape to be subjected to tape processing and a cartridge casing in which the process tape is accommodated and which has a plurality of outer wall faces making a contour of the cartridge casing, and is detachably mounted on a tape processing apparatus. The tape cartridge is handled in a state in which a feeding end of the process tape is slightly projected from a tape feeding port formed in one of the outer wall faces of the cartridge casing. One or more outer wall faces other than the one outer wall face of the cartridge casing have braille placed thereon serving as content indications.

### BACKGROUND OF THE INVENTION

1. Field of the Invention

The present invention relates to a tape cartridge accommodating a process tape (e.g., print tape) and a tape processing apparatus on which the tape cartridge is detachably mounted.

2. Description of the Related Art

Known cartridges of recording media such as a disk and a magnetic tape are of a type affixed with a label having braille placed thereon, providing information of musical sound signals, image signals, etc. recorded in the recording media.

On the other hand, with respect to a tape cartridge which is detachably mounted on a tape processing apparatus (such as a printing apparatus and a braille embossing apparatus) and which has a tape feeding port from which the feeding end of a process tape is slightly projected in use, it is not typical to have braille placed thereon.

Meanwhile, with touch-typing skills even a totally blind person (visually-impaired person) is allowed to fully use a printing apparatus and a braille embossing apparatus capable of printing characters or the like, and embossing braille on a process tape, particularly if they are linked to personal computers. In other words, a tape cartridge with braille enables even a totally blind person to positively make printing labels or braille labels.

In using the above-described cartridge with the feeding end of a process tape projected, however, there arises a possibility that the totally blind person unintentionally pushes back the feeding end into the cartridge when recognizing braille with fingertips (hereinafter referred to as touch-reading), which in turn could make it impossible to feed out the process tape.

### SUMMARY OF THE INVENTION

In view of the above drawbacks, it is an advantage of the present invention to provide a tape cartridge which prevents a process tape from falling inside the tape cartridge and is made available for a totally blind person, and a tape processing apparatus on which the tape cartridge is detachably mounted.

According to one aspect of the present invention, there is provided a tape cartridge which includes a process tape to be subjected to tape processing and a cartridge casing in which the process tape is accommodated and which has a plurality of outer wall faces making a contour of the cartridge casing and is detachably mounted on a tape processing apparatus. The tape cartridge is handled in a state where a feeding end of the process tape is slightly projected from a tape feeding port formed in one of the outer wall faces of the cartridge casing. One or more outer wall faces other than said one outer wall face of the cartridge casing have braille placed thereon serving as content indications.

With this configuration, the braille placed on the outer wall faces of the cartridge casing enables even a totally blind person (visually-impaired person) to easily understand contents of the cartridge. Further, the braille is placed on the outer wall faces other than said one outer wall face where the tape feeding port is formed, thereby preventing the totally blind person from unintentionally pushing back the feeding end when touch-reading the braille. Thus, it is made possible to prevent the process tape from falling inside the cartridge, and enable even the totally blind person to use the tape cartridge.

In this case preferably, said one or more other outer wall faces constitute at least one outer wall face from either a pair of holding outer wall faces to be held or a pushing outer wall face used to be mounted on the tape processing apparatus.

With this configuration, the braille can be placed on the faces where the totally blind person necessarily touches it when handling the tape cartridge, thereby easily notifying him/her of the presence of the braille. Further, the totally blind person are enabled to touch-read the braille and mount the tape cartridge at the same time.

In this case preferably, the cartridge casing provides compatibility and has a plurality of types with different contour shapes, and said one or more other outer wall faces constitute at least one of the outer wall faces forming the different contour shapes.

In general, the totally blind person is likely to discriminate a plurality of types of tape cartridges on the basis of the contour shapes thereof.

With this configuration, since the totally blind person is enabled to touch the braille when discriminating the contour shapes of the cartridge casings different between a printing tape cartridge and a braille embossing tape cartridge, he/she can be more easily notified of the presence of the braille.

In this case preferably, the braille indicates at least one of the content indications including a tape width of the process tape, a tape color of the process tape, contents of the tape processing, and the process tape as being an object of the tape processing.

In this case preferably, the cartridge casing further accommodates an ink ribbon to be subjected to the tape processing, and the content indications include a ribbon color of the ink ribbon.

With this configuration, the totally blind person is enabled to touch-read the content indications of the process tape (and the ink ribbon) indicated by the braille, and uses the tape cartridge according to intended purposes.

In this case preferably, the braille is integrally formed with the cartridge casing.

With this configuration, the braille can easily be formed collectively together with the cartridge casing.

In this case preferably, the braille is formed on a label affixed to the cartridge casing.

With this configuration, the braille with different content indications can easily be placed on the cartridge casing without modifying the same.

According to another aspect of the present invention, there is provided a tape processing apparatus on which the tape cartridge as defined in the above is detachably mounted, wherein at least either a printing process or a braille embossing process is performed on a process tape as tape processing.

With this configuration, even a totally blind person is enabled to use the tape cartridge based on content indications, and efficiently performs tape processing, i.e., printing and braille embossing on the process tape according to intended purposes.

In this case preferably, the tape processing apparatus is provided with an interface connected to an information processing apparatus which enables the totally blind person to perform data-entry.

With this configuration, the totally blind person is enabled to perform data-entry through the information processing apparatus, thus achieving more efficient tape processing. In this case, the information processing apparatus is configured in such a manner that the totally blind person performs data-entry with touch-typing skills through a keyboard or a previously-installed voice input software. Interface connection may be either by wire or wireless means.

### BRIEF DESCRIPTION OF THE DRAWINGS

The above and other objects and the attendant features of the present invention will become readily apparent by reference to the following detailed description when considered in conjunction with the accompanying drawings wherein:

FIG. 1 is an illustration of a tape processing system;

FIGS. 2A and 2B are a plan view and a side view of a braille embossing assembly;

FIG. 3 is a block diagram showing a control configuration of the tape processing system;

FIGS. 4A and 4B are sectional views of a first cartridge and a second cartridge, showing their respective internal structures;

FIGS. 5A and 5B are perspective views of the first cartridge and the second cartridge, showing their respective appearances; and

FIGS. 6A to 6D are developments of strip labels embossed in braille, showing a tape width, a tape color, contents of a tape processing and a process tape as being an object of the tape processing, and a two-stage arrangement.

### DETAILED DESCRIPTION OF THE INVENTION

Hereinafter, a description will be made about a tape processing system to which a tape cartridge and a tape processing apparatus of the present invention are applied, with reference to the accompanying drawings. The tape processing system is configured in such a manner that even a totally blind person (visually-impaired person) can easily use a, printing-and-embossing composite apparatus (tape processing apparatus: hereinafter referred to as “composite apparatus”).

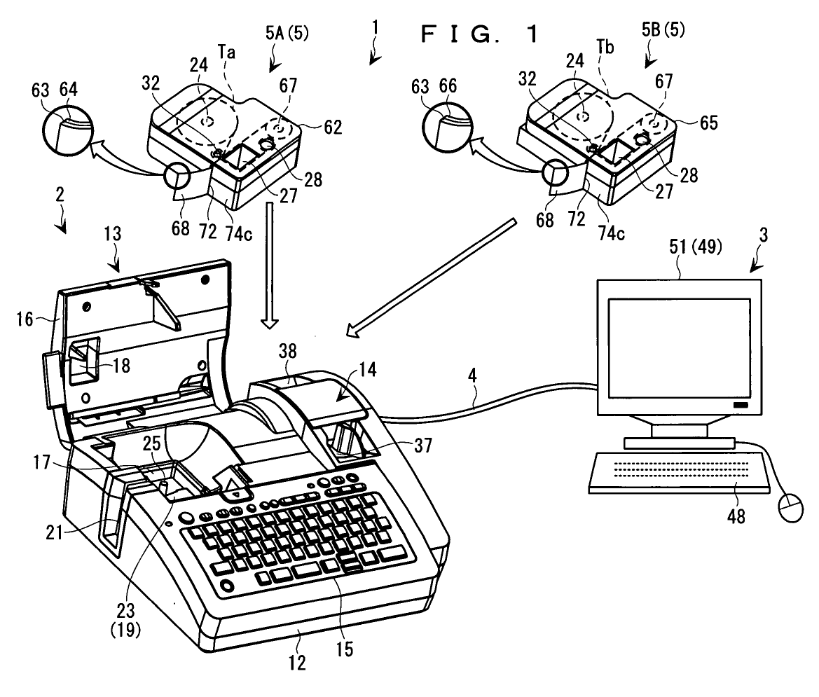

Referring to FIG. 1, the tape processing system 1 will be described. According to the tape processing system 1, the composite apparatus 2 which performs a printing process and a braille embossing process on a process tape (print tape Ta and braille tape Tb) and an information processing apparatus 3 (personal computer) which enables the user to perform data-entry are connected to each other through a cable 4, so as to build its hardware as a whole. Further, with the tape processing system 1, the information processing apparatus 3 and the composite apparatus 2 are linked to each other by an exclusive software installed in the information processing apparatus 3, which in turn performs a printing process and a braille embossing process on a process tape of a tape cartridge 5 mounted on the composite apparatus 2, so as to form labels.

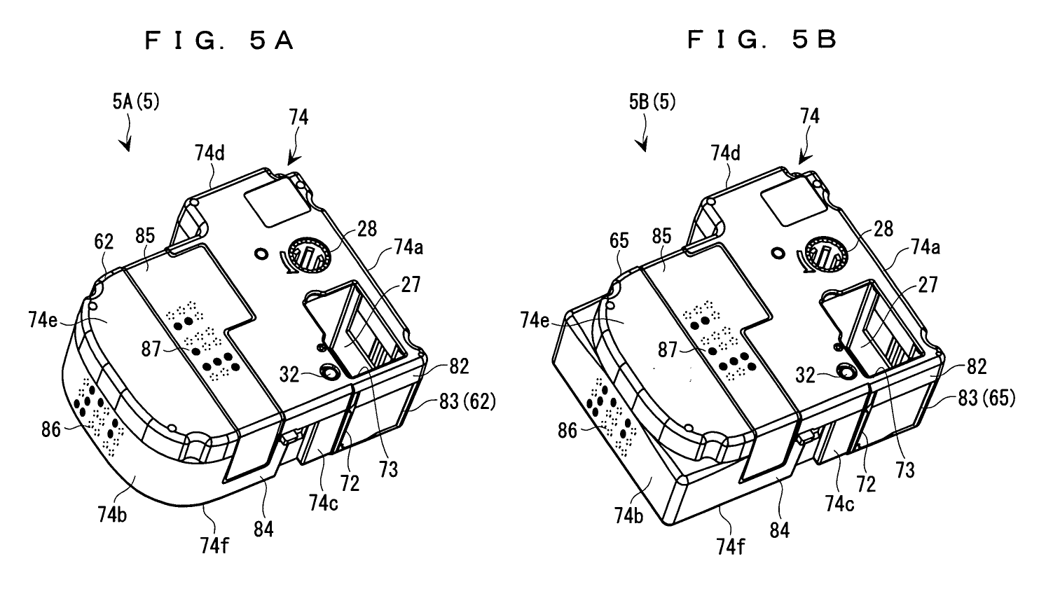

The tape cartridge 5 is classified broadly into two types. More specifically, a first cartridge 5A accommodates the print tape Ta (process tape) which is subjected to a printing process in a winding manner. A second cartridge 5B accommodates the braille tape Tb (process tape) which is subjected to a printing process and a braille embossing process in a winding manner. These two types of the first cartridge 5A and the second cartridge 5B have braille placed thereon (see FIGS. 5A and 5B), thereby enabling even the totally blind person to easily handle the cartridge (description will be made hereinafter).

The composite apparatus 2 has an contour formed by an apparatus casing 12, and two main units of a printing section 13 and an embossing section 14, which prints ink characters on the print tape Ta and embosses braille on the braille tape Tb, respectively, are accommodated in the casing 12. Further, the printing section 13 constitutes the principal part of the composite apparatus 2 and the embossing section 14 is built into the right rear part of the composite apparatus 2.

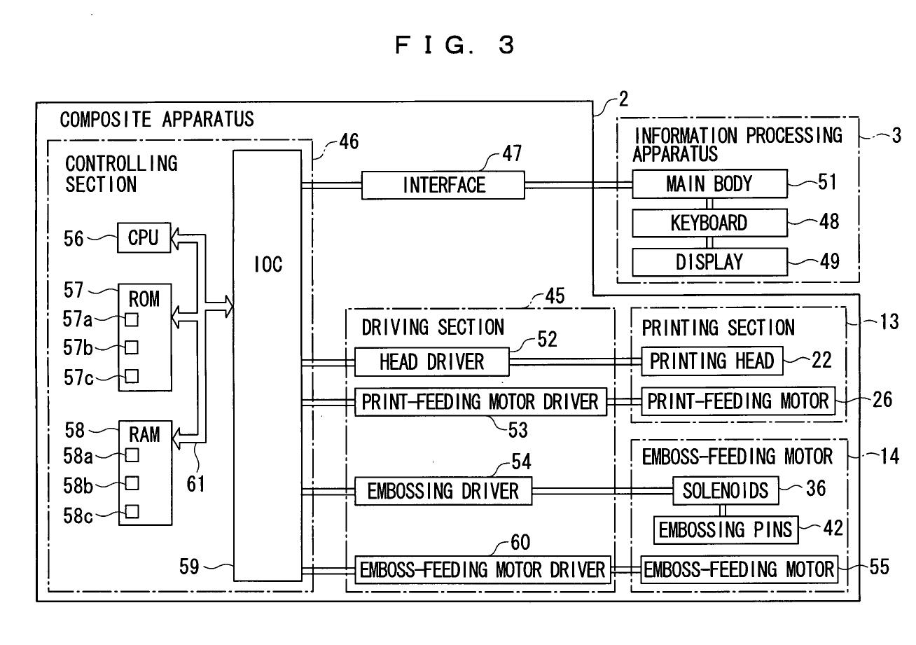

The printing section 13 has a front top face where an exclusive keyboard 15 provided with various input keys is arranged and has a rear top face to which an opening/closing cover 16 is attached. At the front face of the opening/closing cover 16, there is arranged a display (not shown). Inside the opening/closing cover 16, there is provided a recessed cartridge mounting section 17 on which the tape cartridge 5 is mounted. At the left part of the opening/closing cover 16, there is provided a discriminating window 18 which discriminates the mounting/non-mounting of the first cartridge 5A in its closed state. On the right side face of the apparatus casing 12, there are provided a power supply port (not shown) for power supply and a female connector (interface 47, see FIG. 3) for connection with the cable 4.

On the left side face of the apparatus casing 12, there is provided a tape ejecting port 21 which connects the cartridge mounting section 17 with the outside. At the tape ejecting port 21, a cutting section (not shown) is arranged from the inside of the apparatus casing 12. The cutting section constitutes a motor-driven full cutter and a half cutter which full-cuts and half-cuts the print tape Ta (braille tape Tb).

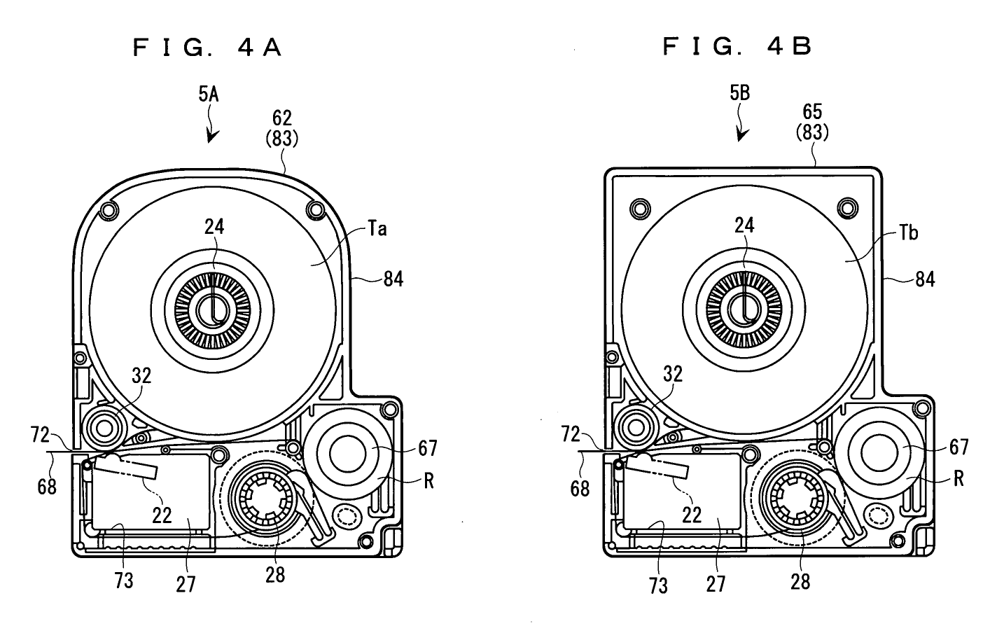

The cartridge mounting section 17 is provided with: a head unit 23 with a head cover 19 including a printing head 22 (see FIGS. 4A and 4B) composed of a thermal head; a platen driving shaft (not shown) arranged at a position opposite to the printing head 22; a reel driving shaft (not shown) which reels an after-mentioned ink ribbon R (see FIGS. 4A and 4B); and a positioning projection 25 for a tape reel 24 (see FIGS. 4A and 4B). Note that the head unit, the platen driving shaft, the reel driving shaft, and the positioning projection are arranged in a standing state. In addition, at the bottom of the cartridge mounting section 17, there are embedded a print-feeding motor 26 (see FIG. 3) which causes the platen driving shaft and the reel driving shaft to rotate, and a torque transmission mechanism (not shown).

When the tape cartridge 5 is mounted on the cartridge mounting section 17, the head unit 23, the positioning projection 25, the reel driving shaft, and the platen driving are inserted into a through hole 27, a tape reel 24, a ribbon taking-up reel 28, and a platen roller 32 of the tap cartridge 5, respectively. With the print tape Ta (braille tape Tb) and the ink ribbon R sandwiched, the printing head 22 comes into contact with the platen roller 32 to enable ink-characters printing (see FIGS. 4A and 4B). Then, based on inputted ink-characters data, the printing head 22 drives the print tape Ta fed out from the platen roller 32, so that the ink-characters printing is performed. The print tape Ta (braille tape Tb), which has been subjected to the ink-characters printing, is cut off (full cut or half cut) by the cutting section, and fed to the outside of the apparatus via the tape ejecting port 21. To perform braille embossing, said cut-off braille tape Tb is manually fed into the embossing section 14.

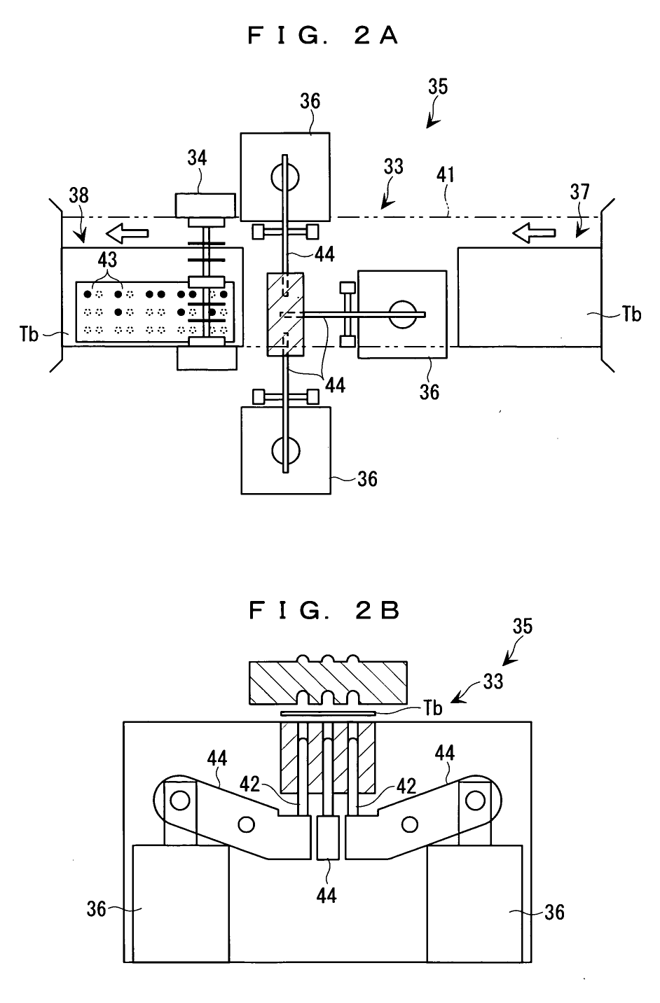

As shown in FIGS. 2A and 2B, the embossing section 14 includes a braille embossing assembly 35 constituting a main unit in which an embossing unit 33 and a tape feeding mechanism 34 are built in an apparatus frame. The embossing unit 33 has three embossing pins 42 which perform embossing in conjunction with three solenoids 36 serving as a driving source. The three embossing pins 42 are selectively driven to emboss braille 43 (a plurality of embossing convex portions) on the braille tape Tb which is caused to travel on a tape traveling path 41 from a tape guiding port 37 to a tape delivering port 38 by the tape feeding mechanism 34. Between each of the solenoids 36 and the corresponding embossing pins 42, there is connected a rotary link 44 which pushes up the embossing pin 42 in response to sucking actions (excitation) of the solenoid 36, so as to perform braille embossing on the braille tape Tb. Note that each of the three solenoids is driven with a time interval.

Referring next to FIG. 3, a description will be made about a control configuration of the tape processing system 1 according to the present embodiment. The tape processing system 1 is composed of: the information processing apparatus 3 as a user interface; the printing section 13 which performs ink-characters printing; the embossing section 14 which performs braille embossing; a driving section 45 which drives each section; a controlling section 46 which is connected to each section and controls the entire composite apparatus 2; and an interface 47 which connects the information processing apparatus 3 with the controlling section 46 of the composite apparatus 2.

The information processing apparatus 3 is in the form of a personal computer, and has a keyboard 48 complying with the JIS (Japanese Industrial Standards), a main body 51, and a display 49. The main body 51 has installed therein input editing programs for displaying an input editing screen on the display 49. The input editing programs present various process modes (a first process mode: ink characters only, a second process mode: braille only, a third process mode: ink characters and braille in combination). The input editing programs have the user perform data-entry in accordance with a predetermined procedure to create text data which forms the basis of a tape processing in the composite apparatus 2. The text data is constituted of character data consisting of character information to be printed, discrimination data which discriminates each of the process modes, or the like. Although the interface 47 has the cable 4 (see FIG. 1) which physically connects the composite apparatus 2 with the information processing apparatus 3, input/output of information (data transfer) may be performed via radio communication.

The driving section 45 has: a head driver 52 which drives the printing head 22; a print-feeding motor driver 53 which drives the print-feeding motor 26; an embossing driver 54 which drives the solenoids 36 and the embossing pins 42 of the embossing section 14; and an emboss-feeding motor driver 60 which drives an emboss-feeding motor 55 of the embossing section 14. The driving section 45 drives each of the actuators (solenoids and motors). Note that a cutter motor driver which drives the cutting section is omitted.

The controlling section 46 has a CPU 56, a ROM 57, a RAM 58, and an input/output controller 59 (hereinafter referred to as “IOC”), each of which is connected to one another through an internal bus 61. The ROM 57 has: a control program block 57a which stores control programs for controlling various processes such as a printing process and a braille embossing process with the CPU 56; a control data block 57b which stores characters-font data for ink-characters printing, character-size data, braille-font data for braille embossing, control data for controlling embossing of braille data, or the like; and a conversion program block 57c which stores a conversion program for converting the text data sent from the information processing apparatus 3 into either ink-characters data or braille data.

The RAM 58 has, in addition to various work area blocks 58a to be used as a flag, etc., an ink-characters data block 58b which stores generated ink-characters data; and a braille data block 58c which stores generated braille data. In other words, the RAM 58 is used as a work area for control processes. Further, the RAM 58 is always battery-protected for holding stored data in case of power-off.

The IOC 59 has incorporated therein a logic circuit which complements functions of the CPU 56 and handles interface signals with various peripheral circuits through a gate array and custom LSI. With this configuration, the IOC 59 receives into the internal bus 61 input data or control data through the exclusive keyboard 15 either with or without processing the same. In addition, the IOC 59 outputs to the driving section 45 data or control signals outputted to the internal bus 61 from the CPU 56 either with or without processing the same while interlocking with the CPU 56.

When the user (totally blind person) with touch-typing skills performs data-entry through the keyboard 48 in accordance with the input editing programs and gives instructions to the main body 51 of the information processing apparatus 3 to start a printing process and a braille embossing process, the text data temporarily stored in the main body 51 is sent to the CPU 56 of the composite apparatus 2. At the same time, the CPU 56 activates the control programs and the conversion program read out from the ROM 57.

The conversion program causes discrimination data out of the text data to be read into the CPU 56, converts either character data of the text data into either or both of the ink-characters data and the braille data to provide the same to the control programs. Based on the data, the control programs output control signals to the driving section 45 through the IOC 59. In response to the control signals, the head driver 52 and the embossing driver 54 of the driving section 45 directly drive the printing section 13 and the embossing section 14 to perform the printing process and the braille embossing process on the print tape Ta (braille tape Tb). Needless to say, it is possible to enter data through the exclusive keyboard 15 of the composite apparatus 2 without the intermediary of the information processing apparatus 3, so as to perform various operations.

Referring now to FIGS. 1, 4A, and 4B, a description will be made about a first cartridge 5A and a second cartridge 5B. The first cartridge 5A has a first cartridge casing 62 from which the print tape Ta is freely fed out and from/to which the ink ribbon R is freely fed out/taken up. The print tape Ta is composed of a record tape 63 having an adhesive layer (not shown) on the back side thereof and of a release tape 64 affixed to the record tape 63 by the adhesive layer. The release tape 64 prevents dust or the like from adhering to the adhesive layer until the time the record tape 63 is used as a label, and it is made of a quality paper or the like whose face is siliconized. Note that the print tape Ta has a plurality of types of tape widths such as 6 mm, 12 mm, 18 mm, 24 mm, and 36 mm, with the ink ribbon R having a plurality of types of ink colors.

The second cartridge 5B has a second cartridge casing 65 from which the braille tape Tb is freely fed out and from/to which the ink ribbon R is freely fed out/taken up. The braille tape Tb is composed of the record tape 63 similar in configuration to the print tape Ta and of a release tape 66 for braille different from that of the print tape Ta.

The release tape 66 for braille of the braille tape Tb permits embossing force generated by the embossing pins 42 to be thoroughly transmitted to the record tape 63 and prevents dust or the like from adhering to the adhesive layer or the like. The release tape 66 for braille has a release substrate layer made of polyethylene/polypropylene copolymer with smaller shock absorbing force than the release tape 64 of the print tape Ta. Note that the braille tape Tb has tape widths of 12 mm and 24 mm and a plurality of tape types varying in tape color, ink color, etc.

FIGS. 4A and 4B are sectional views of the first cartridge 5A and the second cartridge 5B, showing their respective internal structures. As shown in the figures, the first cartridge 5A and the second cartridge 5B are identical in internal structure and interchangeable with each other although they accommodate the print tape Ta and the braille tape Tb, respectively. To take the first cartridge 5A as an example, it has the first cartridge casing 62, making the contour thereof, in which are accommodated the tape reel 24 winding the print tape Ta, a ribbon feeding reel 67 winding the ink ribbon R having substantially the same width as the print tape Ta, the ribbon taking-up reel 28, and the platen roller 32. The ribbon feeding reel 67 and the ribbon taking-up reel 28 are arranged at the right lower part of the cartridge casing and the platen roller 32 at the left lower part thereof. Note that the print tape Ta wound around the tape reel 24 is accommodated in the first cartridge casing 62 in such a manner that a feeding end 68 of the print tape Ta is slightly projected from a tape leading slit 72 (tape leading port) formed in a left-side wall face 74c (one of the outer wall faces, see FIGS. 5A and 5B) of the first cartridge casing 62.

At the left lower part of the tape reel 24, there is formed the through hole 27, to which the head unit 23 is connected, with the platen roller 32 which fits the platen driving shaft of the apparatus arranged to correspond to the position where the print tape Ta and the ink ribbon R are overlapped with each other. The ink ribbon R fed out from the ribbon feeding reel 67 is fed in such a manner as to travel around an opening wall 73 constituting the through hole 27 and taken up by the ribbon taking-up reel 28. The print tape Ta fed out from the tape reel 24 overlaps with the ink ribbon R fed out from the ribbon feeding reel 67 at the position of the platen roller 32, and is printed with thermal transfer of the printing head 22. A printed tape Ta is ejected from the tape leading slit 72, and the ink ribbon R is taken up by the ribbon taking-up reel 28.

As shown in FIGS. 5A and 5B, the first cartridge casing 62 and the second cartridge casing 65 each have an appearance constituted by six outer wall faces 74 of a front wall face 74a, a rear wall face 74b, a left-side wall face 74c, a right-side wall face 74d, a top wall face 74e, and a bottom wall face 74f, all of which are different from one another in their contours (from the viewpoint of flat shapes). The first and second cartridge casings 62 and 65 are composed of an upper casing 82 (cover casing) and a lower casing 83 (body casing), each of which are resin-molded. With respect to shape, the upper casings 82 of the first and the second cartridge casings 62 and 65 are identical, while the lower casings 83 thereof are different.

The upper casing 82 and the lower casing 83 of the first cartridge casing 62 are formed in such a manner that a main accommodating part 84 around the tape reel 24 is R-shaped and the cartridge casing has a flat shape (in appearance) with roundness as a whole, showing a “bold L”-shape when viewed in the plane. Note that the lower casing 83 and the upper casing 82 are made of a colored resin and a transparent resin, respectively.

The second cartridge casing 65 is formed in such a manner that the upper casing 82 is similar in shape (appearance) to the first cartridge casing 62 and the lower casing 83 is different in shape from the first cartridge casing 62, with the result that the main accommodating section 84 around the tape reel 24 taking the form of an approximate square which forms a flat structure (in appearance) with angle as a whole, showing a “bold L”-shape when viewed in the plane. Accordingly, the first cartridge casing 62 and the second cartridge casing 65 have a flat face orthogonal to a mounting direction thereof in which contour shape of the main accommodating section 84 varies.

The first cartridge 5A and the second cartridge 5B thus formed are mounted on the cartridge mounting section 17 from above the apparatus, with the upper casing 82 up and the lower casing 83 down.

Next, a description will be made about braille placed on the first cartridge 5A and the second cartridge 5B. To prevent the totally blind person from pushing back the feeding end 68 when touch-reading braille, the braille is to be placed on at least one of the front wall face 74a, the rear wall face 74b, the right-side wall face 74d, the top wall face 74e, and the bottom wall face 74f other than the left-side wall face 74c of the first cartridge 5A and the second cartridge 5B. In FIGS. 5A and 5B, the left side of the figures shows the “rear” and the right side thereof “front” for illustrative purposes.

In the present embodiment, braille 86 and 87 are placed (formed) on the rear wall face 74b out of the front wall face 74a and the rear wall face 74b which serve as a pair of holding outer wall faces 74 to be held, and the top wall face 74e which serves as a pushing outer wall face used to be mounted on the cartridge mounting section 17 of the composite apparatus 2, respectively. The braille 86 placed on the rear wall face 74b is molded at the same time as the lower casing 83 of the first and second cartridges 5A and 5B, and is integrally formed with the lower casing 83 (cartridge casing). Further, the braille 87 placed on the top wall face 74e is formed in a strip label 85 to be affixed to the upper casing 82 of the first and second cartridges 5A and 5B. This enables the user (blind) to necessarily touch-read braille when mounting the tape cartridge 5 by hand on the composite apparatus 2.

More specifically, on the lower casing 83 of the rear wall face 74b of the first and second cartridges 5A and 5B, there is placed braille (representing a figure of “12”) 86 indicating as content indications that the print tape Ta (braille tape Tb) has a tape width of 12 mm. Although the tape cartridge 5 accommodating the print tape Ta with a tape width of 12 mm is used in exemplification of the present embodiment, braille (representing a figure of “24”) is placed on the tape cartridge 5 accommodating the print tape Ta with a tape width of 24 mm. With respect to a plurality of types of the tape cartridges 5 having different tape widths of the print tape Ta, the lower casing 83 with a different depth is used depending on the tape width involved, while the upper casing 82 is used in common. Further, the rear wall faces 74b of the first cartridge 5A and the second cartridge 5B serve as the outer wall face 74 forming different contour shapes, thereby making it easier for the totally blind person to touch the braille 86 in distinguishing the first cartridge 5A from the second cartridge 5B.

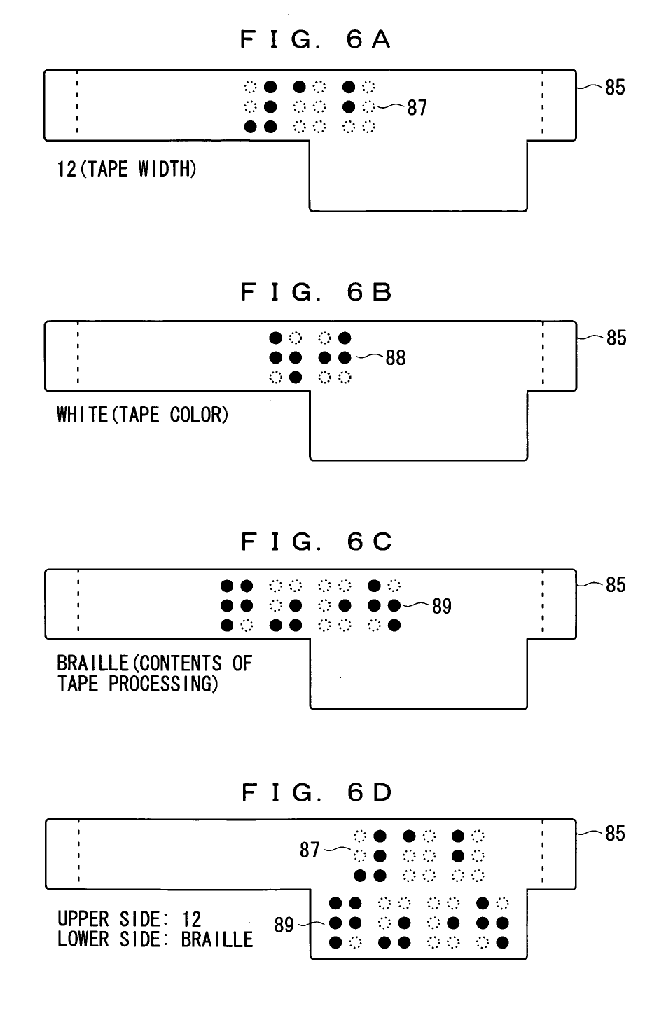

The strip label 85, as shown in developments of FIGS. 6A to 6D, is designed to have one of the following braille formed thereon: braille 87 (see FIG. 6A) representing a figure of “12” indicative of the tape width of 12 mm of the print tape Ta (braille tape Tb), braille 88 (see FIG. 6B) representing “white” indicative of the tape color of the print tape Ta (braille tape Tb), and braille 89 (see FIG. 6C) representing the contents of a braille embossing process (tape processing) and the braille tape Tb as being an object of the braille embossing process (tape processing).

Further, as shown in FIG. 6D, the strip label 85 may have the braille 87 representing the figure “12” and the braille 89 representing “braille” itself arranged on the upper and lower sides thereof. Although not shown in the figure in this case, the strip label 85 may be arranged in such a manner that the braille representing the tape color of the print tape Ta (braille tape Tb) and the ribbon color of the ink ribbon are indicated on the upper side and the lower side thereof, respectively. Braille is placed on the tape cartridge 5 through the strip label 85, which in turn makes it possible to easily place braille with different content indications on both the first and second cartridge casings 62 and 65 without modifying the same. By affixing the label forming the braille on the rear wall face 74b, it is possible to place the braille on the tape cartridge 5.

According to the present embodiment as described above, braille is placed on the rear wall face 74b and the top wall face 74e other than the left-side wall face 74c where the tape ejecting slit (tape leading port) 72 is provided, thereby enabling even the totally blind person to handle the tape cartridge 5 as well as a visually-normal person, and preventing the totally blind person from pushing back the feeding end 68 when touch-reading braille. Thus, with braille placed on the tape cartridge 5, it is made possible to prevent the print tape Ta (braille tape Tb) from falling inside the cartridge, and enable even the totally blind person to use the tape cartridge 5.

Note that the content indications of braille and the outer wall faces 74 placed therewith (other than the left-side wall face 74c) are not limited to the present embodiment. Further, according to the present embodiment, the totally blind person with touch-typing skills performs data-entry through the keyboard 48. Alternatively, the totally blind person is enabled to perform data-entry by using voice input of a commercially available voice input software. This enables even the totally blind person without touch-typing skills to perform data-entry, thus making the cartridge 5 available for more totally blind persons.

It is further understood by those skilled in the art that the foregoing is the preferred embodiment of the present invention, and that various changes and modifications may be made without departing from the spirit and scope thereof.

What is claimed is:

1. A tape cartridge which includes a process tape to be subjected to tape processing and a cartridge casing in which the process tape is accommodated and which has a plurality of outer-wall faces making a contour of the cartridge casing and is detachably mounted on a tape processing apparatus,
the tape cartridge being handled in a state where a feeding end of the process tape is slightly projected from a tape feeding port formed in one of the outer wall faces of the cartridge casing, wherein
one or more outer wall faces other than said one outer wall face of the cartridge casing have braille placed thereon serving as content indications.

2. The tape cartridge according to claim 1, wherein
said one or more other outer wall faces constitute at least one outer wall face from either a pair of holding outer wall faces to be held or a pushing outer wall face used to be mounted on the tape processing apparatus.

3. The tape cartridge according to claim 1, wherein
the cartridge casing provides compatibility and has a plurality of types with different contour shapes, and
said one or more other outer wall faces constitute at least one of the outer wall faces forming the different contour shapes.

4. The tape cartridge according to claim 1, wherein
the braille indicates at least one of the content indications including a tape width of the process tape, a tape color of the process tape, contents of the tape processing, and the process tape as being an object of the tape processing.

5. The tape cartridge according to claim 4, wherein
the cartridge casing further accommodates an ink ribbon to be subjected to the tape processing, and
the content indications include a ribbon color of the ink ribbon.

6. The tape cartridge according to claim 1, wherein
the braille is integrally formed with the cartridge casing.

7. The tape cartridge according to claim 1, wherein
the braille is formed on a label affixed to the cartridge casing.

8. A tape processing apparatus on which the tape cartridge as defined in any of claims 1 to 7 is detachably mounted, wherein
at least either a printing process or a braille embossing process is performed on a process tape as tape processing.

9. The tape processing apparatus according to claim 8, further comprising
an interface connected to an information processing apparatus which enables a totally blind person to perform data-entry.
